(19) United States
(12) Patent Application Publication
(10) Pub. No.: US 2018/0099488 A1
(43) Pub. Date: Apr. 12, 2018

(54) High Strength Laminate Glass Structure and Method of Making Same

(71) Applicant: Rayotek Scientific, Inc., San Diego, CA (US)

(72) Inventor: William Raggio, Del Mar, CA (US)

(21) Appl. No.: 15/726,551

(22) Filed: Oct. 6, 2017

Related U.S. Application Data
(60) Provisional application No. 62/404,888, filed on Oct. 6, 2016.

(51) Int. Cl. B32B 17/10; C03C 27/10

(52) U.S. Cl. CPC B32B 17/10752; F41H 5/26; C03C 27/10

(57) ABSTRACT

A laminate structure has first and second polymer layers with a glass layer between the first and second polymer layers. The glass layer is fused to the first and second polymer layers. The glass layer is encapsulated by the first and second polymer layers, and the glass layer is in compression.

### RELATED APPLICATION

This application claims the benefit of provisional Patent App. Ser. No. 62/404,888, filed on Oct. 6, 2016.

### BACKGROUND AND SUMMARY

The present disclosure relates to a laminate glass structure with improved impact resistance and strength. The laminate structure may be formed from alternating layers of a polymer and a glass with the glass being encapsulated in the polymer in a manner such that the glass provides strength and rigidity for the laminate structure and the polymer provides protection for the glass and forces the glass into compression, further strengthening the laminated structure.

### DESCRIPTION OF THE DRAWINGS

FIG. 1 shows a process flow for forming one embodiment of a laminate structure.

FIG. 2 shows a front schematic view of an alternate embodiment of a laminate structure.

FIG. 3 shows an edge, cross-sectional view of the laminate structure of FIG. 2.

FIG. 4 shows a front schematic view of another alternate embodiment of a laminate structure.

FIG. 5 shows an edge, cross-sectional view of the laminate structure of FIG. 4.

### DETAILED DESCRIPTION

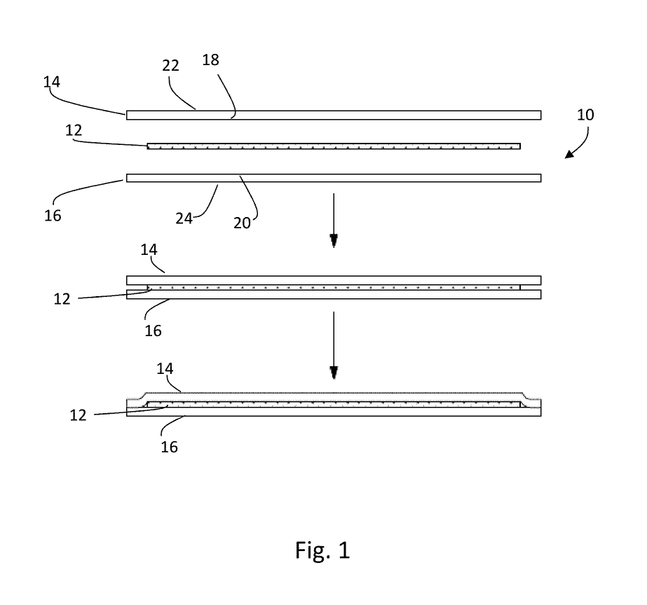

FIG. 1 shows a schematic process flow for forming one embodiment of a glass laminate structure 10. A glass layer 12 is disposed between two polymer layers 14,16. Each polymer layer has internal surfaces 18,20 and external surfaces 22,24. One surface of the glass layer 12 may be adjacent to the first polymer layer internal surface 18 with the first polymer layer external surface 22 being exposed from the laminate structure. The other surface of the glass layer may be adjacent to the second polymer layer internal surface 20 with the second polymer layer external surface 24 being exposed from the laminate structure. The polymer layers protect the glass layer, for instance, to improve impact resistance and to withstand penetration, while the glass layer acts to stiffen the laminate structure and provide support for the polymer layers, for instance, when the laminate structure is subjected to high temperatures. In this way, the glass layer prevents distortion or sagging of the laminates structure in the event of exposure to prolonged heating.

The polymer layers 14,- 16 may have peripheral edges that are greater in dimension than the peripheral edges of the glass layer. The inner and outer polymer layers 14,- 16 may be arranged relative to the glass layers such that their respective peripheral edges surround the glass layer peripheral edges. The laminate structure may then be heated to below the melting point of the polymer layers forming a laminate comprising the polymer layers with the glass layer disposed therebetween. The heating of the inner and outer polymer layers and the glass layer fuses the polymer layers to the glass layer. The heating may take place in a vacuum environment and may include degassing so as to remove any gasses entrapped between the polymer and the glass layers. After degassing, heating of the laminate may continue at a temperature corresponding to the softening point of the polymer. As shown in FIG. 1, because the inner and outer polymer layers have peripheral edges that are greater in dimension than the peripheral edges of the glass layer, one layer of polymer will sag downward toward the other layer of polymer, thereby fully encapsulating the glass layer in the polymer. Once the inner layer is edge sealed to the outer layer, the vacuum can be released, exposing the assembly to atmospheric pressure, eliminating any bubbles, and insuring optimal sealing of the polymer layers to the glass. Further, because the polymer layers have peripheral edges that are greater in dimension that peripheral edges of the glass layer, as the one layer sags toward the other layer, the dimensional thickness of laminate structure as measured between the polymer layers is less at a peripheral edge of the structure than at a center of the structure where the glass layer is disposed between the polymer layers. Because the coefficient of thermal expansion of the polymer layers is considerably higher than the coefficient of thermal expansion of the glass layer, the glass layer is compressed by the polymer layers when the laminate cools. Once the laminate is cooled, the glass layer encapsulated in the polymer layers will be under compression thereby increasing the strength of the overall laminate structure and reducing the potential for the glass layer to be damaged from impact by direct contact. The process may also be performed in a manner where the bottom polymer layer, as shown in FIG. 1, sags toward the top polymer layer, as shown in FIG. 1.

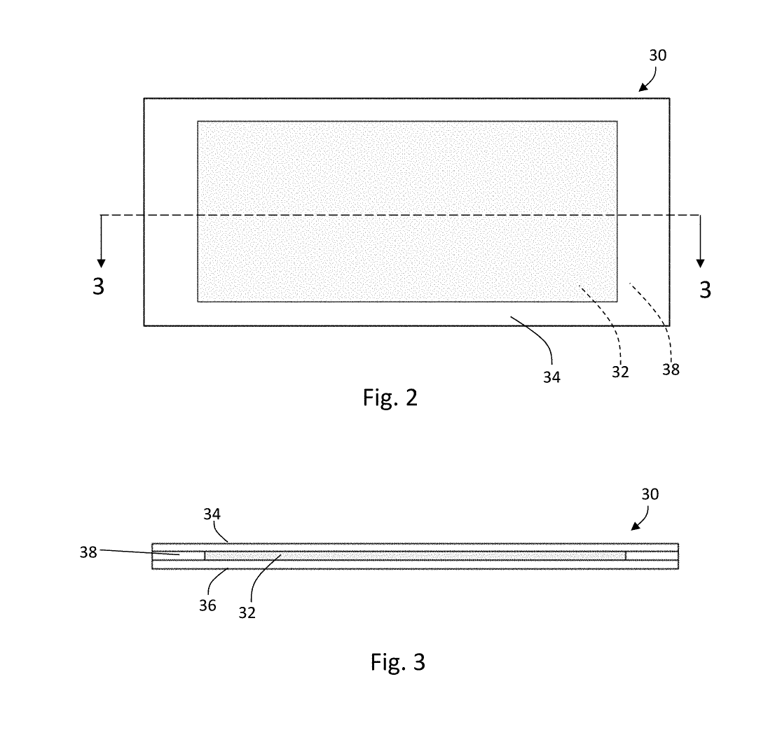

FIGS. 2 and 3 provide detail of an alternate embodiment of a laminate structure 30 which in some respects is similar to that described previously in connection with FIG. 1. In FIGS. 2 and 3, the glass layer 32 is sandwiched between the first and second polymer layers 34,36, and a spacer 38 is interposed between the inner and outer layers around the edges of the glass layer. The spacer 38 may be formed from material that will fuse with the polymer layers. The material for the spacer may be more resistant to softening then the polymer layers. Thus, the spacer 38 may provide additional protection for the laminate structure by preventing delamination of the laminate structure at its edges through heat or impact. Once heated, the spacer 38 and polymer layers 34,36 may fuse to the glass layer 32, whereupon cooling of the laminate structure, the glass layer may be placed in compression in multiple axes. With the glass layer sealed from the external environment, especially at its edges vis-à-vis the spacers, its susceptibility to damage from impact and direct contact may be reduced.

FIG. 2 is a schematic of a front view of the laminate structure. The glass layer 32 may be sandwiched between the first and second polymer layers 34,36 and the spacer 38 may be disposed around the edges of the glass layer between the inner and outer polymer layers. The spacer 38 may comprise a frame within which the glass layer 32 is disposed. A heating method similar to that described previously with reference to FIG. 1 may be employed, but in an embodiment including the spacer, the polymer layer (e.g., the top polymer layer in the drawings) will not sag towards the other polymer layer (e.g., the bottom polymer layer in the drawings), but the layers will bond to the spacer and fuse to the glass layer. Thus, in the embodiment of the laminate structure of FIG. 2-3, the dimensional thickness of laminate structure as measured between the polymer layers is same at the peripheral edge of the laminate structure as at the center of the laminate structure. Once the laminate is cooled, the glass layer may be sealed in the polymer layers and the spacer, and held in compression, including radially inward toward the center of the laminate structure, thereby increasing the strength of the laminate structure.

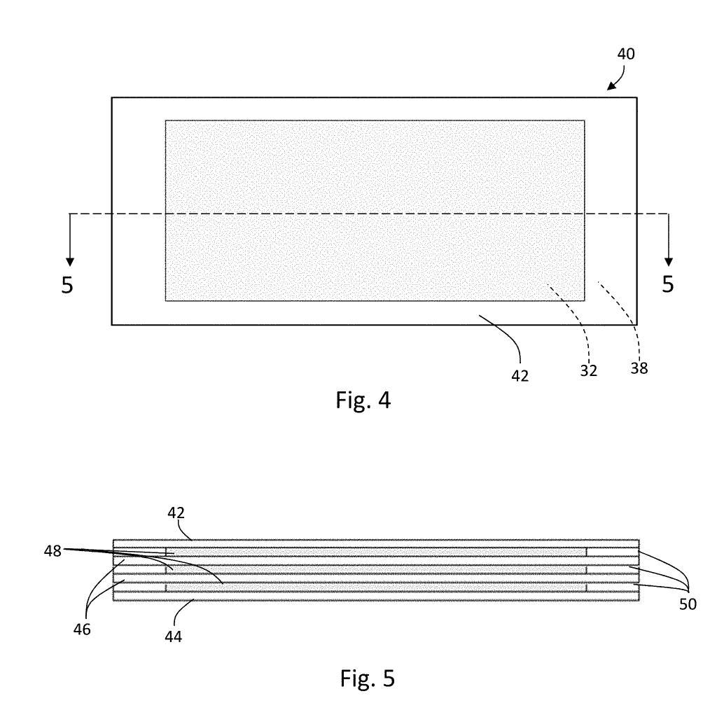

FIGS. 4 and 5 show another embodiment of a laminate structure 40 having a construction similar to the laminate structure of FIGS. 2 and 3. The laminate structure 40 has first and second polymer layers 42,44 with intermediate polymer layers 46, glass layers 48, and spacers 50 therebetween. The exemplary laminate structure 40 shows three glass layers 48, three spacers 50, and two intermediate polymer layers 46 interposed between outer polymer layers 42,44, but the laminate structure could include more spacers, intermediate polymer layers and glass layers. The spacers 50 may surround the outer edges of the glass layers. One or more of the spacers may comprise frames within which the respective glass layer is disposed. Because the edges of the glass layers are encapsulated within the polymer layers and the spacers, there is no slip between the glass layers and the polymer layers, and the glass layers are placed in compression thereby improving strength of the overall laminate structure. Although the embodiment of FIGS. 4-5 show the spacers disposed between the inner and outer polymer layers and the intermediate polymer layer, the spacers may be omitted and the one polymer layer (e.g., the top layer) and intermediate polymer layers may sag toward another polymer layer (e.g., the bottom layer) during heating to encapsulate the glass layers, for instance, as shown with respect to FIG. 1.

In the embodiments described herein, the glass layer may be a borosilicate glass or fused quartz. The glass layer may be formed from an impact resistant glass that may be chemically strengthened. One type of material for the glass layer that has proven effective is sold under the trademark Gorilla Glass provided by Corning, Inc. of Corning, N.Y. The material for the glass layer may also have properties whereby the material maintains its structural integrity up to temperatures of at least 500° C. The polymer layer may be formed from a polycarbonate. The polymer layer may comprise a thermoplastic. For instance, the polymer layer may comprise a material sold under the trademark TEXERON provided by Texstar, LLC of Grand Prairie, Tex. The TEXERON polymer material has been proven effective as it maintains its structural integrity for very high temperatures.

The laminate structure may be used in high impact type applications, for instance, a lens for a protective shield, or a ballistic window, sight glass, or shield.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A laminate structure comprising first and second polymer layers with a glass layer between the first and second polymer layers, the glass layer being fused to the first and second polymer layers, the glass layer being encapsulated by the first and second polymer layers, and the glass layer being in compression.

2. The laminate structure of claim 1, wherein a dimensional thickness of laminate structure as measured between the first and second polymer layers is less at a peripheral edge of the laminate structure at a center of the laminate structure.

3. The laminate structure of claim 1, wherein a dimensional thickness of laminate structure as measured between the first and second polymer layers is same at a peripheral edge of the laminate structure as at a center of the laminate structure.

4. The laminate structure of claim 1 wherein the glass layer comprises a borosilicate glass.

5. The laminate structure of claim 1 wherein the glass layer comprises fused quartz.

6. The laminate structure of claim 1 wherein the polymer layer comprises polycarbonate.

7. A method comprising:
providing a glass layer with peripheral edges;
providing a first polymer layer with an internal surface and an external surface, and peripheral edges extending between the internal and external surfaces, the first polymer layer peripheral edges being sized larger than the glass layer peripheral edges;
providing a second polymer layer with an internal surface and an external surface, and peripheral edges extending between the internal and external surfaces, the second polymer layer peripheral edges being sized larger than the glass layer peripheral edges;
arranging the first polymer layer internal surface adjacent to the glass layer such that the first polymer layer peripheral edges surround the glass layer peripheral edges;
arranging the second polymer layer internal surface adjacent to the glass layer such that the second polymer layer peripheral edges surround the glass layer peripheral edges;
forming a laminate comprising the first and second polymer layers with the glass layer disposed therebetween including by heating the first and the second polymer layers and the glass layer so as to fuse the polymer layers around the glass layer, encapsulate the glass layer, and place the glass layer in compression.

8. The method of claim 7, further comprising arranging the first and second polymer layers relative to the glass layer in a manner such that a dimensional thickness of laminate structure as measured between the first and second polymer layers is less at a peripheral edge of the laminate structure than at a center of the laminate structure.

9. The method of claim 7, further comprising arranging a spacer between the first and second polymer layers around the glass layer peripheral edges.

10. The method of claim 7 wherein the step of arranging the second polymer layer internal surface adjacent to the glass layer such that the second polymer layer peripheral edges surround the glass layer peripheral edges includes arranging the spacer between the first and second layers.

11. The method of claim 10 wherein the step of arranging the first polymer layer internal surface adjacent to the glass layer such that the first polymer layer peripheral edges surround the glass layer peripheral edges includes arranging the spacer between the first and second polymer layers.

12. The method of claim 10 further comprising providing the spacer with peripheral edges that match the peripheral edges of at least one of first and second polymer layers.

13. The method of claim 10 further comprising:
providing at least one additional glass layer with peripheral edges;
providing at least one additional polymer layer with an internal surface and an external surface, and peripheral edges extending between the internal and external surfaces, the additional polymer layer peripheral edges being sized larger than the additional glass layer peripheral edges; and
arranging the additional polymer layer internal surface adjacent to the additional glass layer such that the additional polymer layer peripheral edges surround the additional glass layer peripheral edges.

14. The method of claim 13 wherein the step of forming the laminate further comprises heating the additional polymer layer with the additional glass layer disposed between the additional polymer layer and one of the first and the second polymer layers so as to fuse the additional polymer layer around the additional glass layer, encapsulate the additional glass layer within the additional polymer layer and one of the first and second polymer layers, and place the additional glass layer in compression.

15. The method of claim 13, further comprising providing at least one additional spacer between the additional polymer layer and one of the first and second polymer layers around the additional glass layer peripheral edges.

16. The method of claim 15 wherein the step of forming the laminate further comprises heating the additional polymer layer and the additional spacer with the additional glass layer disposed between the additional polymer layer and one of the first and the second polymer layers so as to fuse the additional polymer layer and the additional spacer to the additional glass layer, encapsulate the additional glass layer within the additional polymer layer, the additional spacer, and one of the first and second polymer layers, and place the additional glass layer in compression.

17. The method of claim 7 wherein the step of providing the glass layer comprises providing a borosilicate glass.

18. The method of claim 7 wherein the step of providing the glass layer comprises fused quartz.

19. The method of claim 7 wherein the step of providing the first polymer layer comprises polycarbonate.

20. The method of claim 7 wherein the step of providing the second polymer layer comprises polycarbonate.
